(19) United States
(12) Patent Application Publication
(10) Pub. No.: US 2007/0163726 A1
(43) Pub. Date: Jul. 19, 2007

(54) SYSTEM, METHOD, AND APPARATUS FOR WINDOW TREATMENT BLIND HAVING OVERLAPPING SLATS

(76) Inventor: Phil Lewis, Austin, TX (US)

Correspondence Address: BRACEWELL & GIULIANI LLP, P.O. BOX 61389, HOUSTON, TX, 77208-1389, US

(21) Appl. No.: 11/621,652

(22) Filed: Jan. 10, 2007

Related U.S. Application Data
(60) Provisional application No. 60/760,335, filed on Jan. 19, 2006.

(51) Int. Cl. E06B 9/30

(52) U.S. Cl. 160/168.1 R

(57) ABSTRACT

A window blind having overlapping slats for improved opacity includes first and second ladder strings, bridging strings, and louver strings that are attached to first and second slats. The louver strings have first ends that are attached near one end of a first adjacent bridging string. Second ends are attached near one end of a second adjacent bridging string. Each louver string forms a loop that encircles a first slat. The two string pieces that form the loop are joined to each other and the second ladder string at a second end, and are joined at an intermediate position of the louver string. The portion of the louver string extending between the intermediate position and the first end forms a hypotenuse of a right triangle when the loop lays flat with the adjacent bridging string.

This application claims priority to and the benefit of U.S. Provisional Patent Application No. 60/760,335, filed on Jan. 19, 2006, which is incorporated herein by reference.

### BACKGROUND OF THE INVENTION

1. Technical Field

The present invention relates in general to window coverings and, in particular, to an improved system, method, and apparatus for a window treatment blind having overlapping slats for improved opacity.

2. Description of the Related Art

Window treatment, namely the art of decorating the interior of a window, has been subject to fashion change over the years. Earlier in the century spring-loaded pull up shades and two-inch blinds called Venetian blinds were in vogue. In the sixties, the use of drapes rather than blinds or shades was commonly practiced by interior decorators of that time. In the early seventies, Roman shades, which were rolled up from the bottom toward the top by a drawstring, were considered chic. In the late seventies mini-blinds, i.e. those of one-inch depth came into fashion as the preferred window treatment.

Today, the mini-blind continues to be fashionable along with the pleated shade. Pleated shades are constructed of horizontal pleats of a single piece of fabric. They operate much like the shades of old in that viewing can only take place when the shades are drawn open, i.e. raised upwardly from the bottom of the window. Blinds on the other hand offer viewing capability without the necessity of raising them. The blind permits the slats to be oriented parallel to one another, thereby letting light in from the window.

Both children and infirm individuals can operate mini-blinds to change the condition from light emitting to light prevention with minimal effort, in contrast to the operation of a shade or pleated shade. Examples of blind systems and shades are found in a number of patents. For example, U.S. Pat. No. 2,231,778 discloses a typical traditional Venetian blind. This blind uses tape ladders to hold and align the slats. The system has a mechanism for turning a headpiece that raises and lowers the tapes, thereby opening and closing the slats. Traditionally, the slats were wide and the system was heavy.

U.S. Pat. No. 2,512,594 discloses a vertical form of blinds. It states that it prevents the buildup of dust on the blinds and makes them easier to operate than the horizontal blinds. One change in this design is that the vertical slats overlap when closed. When open, they look like ordinary vertical blinds. When closed, the overlapping slats block all light from entering the room, making them more efficient than the standard horizontal blinds. The overlap is achieved by making the slats wider than the space between adjacent slats. Thus, when closed, the end of one vertical slat overlaps the adjacent slat.

U.S. Pat. No. 2,247,260 discloses a typical pleated shade. Here, a solid shade is positioned between a head rail and a bottom rail. The bottom rail can be lifted to open the shade. Unlike blinds, however, there are no slats to open when the shade is closed. Although shades and blinds have worked well over the years, there have been attempts to improve their design. Most blinds leak light, either through the gaps between the slats, or through slots in the slats that the rope ladders pass through. In U.S. Pat. No. 4,076,068, the blinds are positioned between two panes of glass. Thus, the blinds are an integral part of the window itself. When the slats are closed, there are two lines of slats, spaced apart. This acts to reduce the amount of light passing through the blinds to a minimum. Unfortunately, because the blinds are installed within the window, maintenance is difficult. Moreover, changing the color or style of blinds is no easy task.

U.S. Pat. No. 3,851,699 teaches a system of vertical drapes that have “blind-like” characteristics. The drapes are an alternate set of panels. Light transmitting panels are interposed adjacent to light impeding panels. When the drapes are open, the light transmitting panels are aligned parallel to a light source, while the light impeding panels are orthogonal to the light transmitting panels. When closed, the light impeding panels fold over the light transmitting panels, thereby blocking out the light.

U.S. Pat. No. 2,757,727 discloses a system of curved slats. Each curved slat has two curved pieces that rest on a carrier. When open, the slats look like ordinary slats. When closed, the slats are open on one end. The tops of the lower slats contact the bottoms of the slats immediately above them. This produces a continuous overlapped row of slats that works to prevent light leakage between the slats. Although this system may be more effective at limiting light transmission, the system uses thick slats that limit light transmission when open, and are bulkier than a flat set of blinds when closed.

U.S. Pat. No. 4,628,979 discloses a window blind having a plurality of horizontal slats that can be regulated to simulate a pleated window. U.S. Pat. No. 4,651,794 attempts to solve the problem of light leakage by designing a set of blinds that when closed, take on the form of a pleated shade. This system uses a number of curved slats that are connected to two ladder systems. In this way, the slats alternate when the blind is closed, forming a series of “V” shaped panels. These panels take on the appearance of a pleated shade. This works because the rear end of one slat is rotated down to meet the rear end of the slat immediately below it, while the front end of the lower slat is lowered to meet the front end of the next lower slat that rises to meet it. The pattern is repeated for the entire length of the blind. The difficulty with this design is the complex system needed to move the slats in an alternate configuration such as (up, down, up, down, etc.) This not only increases costs, but also increases the likelihood of operating problems with the blinds over time.

U.S. Pat. No. 4,708,188 discloses two pair of cable ladders, which move in opposite directions, to move alternate slats in opposite directions. In addition, U.S. Pat. No. 5,558,146 discloses a blind having transparent base boards and graphic patterns to selectively block or reflect light. Although each of these prior art designs is workable an improved solution would be desirable.

### SUMMARY OF THE INVENTION

One embodiment of a system, method, and apparatus for a window treatment blind having overlapping slats for improved opacity is disclosed. The invention includes first and second ladder strings, bridging strings, and louver strings that are attached to first and second slats. The louver strings have first ends that are attached at or near the same area as one end of a first adjacent bridging string. A set of second ends are attached at or near the same area as one end of a second adjacent bridging string.

Each louver string also forms a loop that encircles a first slat. The size of the loop is closely sized to the first slat to precisely circumscribe it, which avoids modification of the first slats. The first slats may be hinged to or separate from the second slats. The first slats rest on top of the second slats such that a natural hinge is created via leverage and gravity. In addition, the positions of the first and second slats may be reversed, such that the first slats are located below respective ones of the second slats.

The two string pieces that form the loop are joined to each other and the second ladder string at a second end, and are joined at an intermediate position of the louver string. The portion of the louver string extending between the intermediate position and the first end forms a hypotenuse of a right triangle when the loop lays flat with the adjacent bridging string.

The foregoing and other objects and advantages of the present invention will be apparent to those skilled in the art, in view of the following detailed description of the present invention, taken in conjunction with the appended claims and the accompanying drawings.

### BRIEF DESCRIPTION OF THE DRAWINGS

So that the manner in which the features and advantages of the present invention, which will become apparent, are attained and can be understood in more detail, more particular description of the invention briefly summarized above may be had by reference to the embodiments thereof that are illustrated in the appended drawings which form a part of this specification. It is to be noted, however, that the drawings illustrate only some embodiments of the invention and therefore are not to be considered limiting of its scope as the invention may admit to other equally effective embodiments.

FIGS. 1A-1C are side views of a portion of one embodiment of a horizontal overlapping blind apparatus, without first and second blind slats in place, showing a series of positions thereof, and is constructed in accordance with the present invention;

FIGS. 2A-2C are side views of a portion of the horizontal overlapping blind apparatus, without the first and second blind slats in place, showing another series of positions thereof, and is constructed in accordance with the present invention;

FIGS. 3A-3C are side views of a portion of the overlapping blind apparatus, with the blind slats in place, showing the series of positions depicted in FIGS. 1A-1C, respectively;

FIGS. 4A-4C are side views of a portion of the overlapping blind apparatus, with the blind slats in place, showing the series of positions depicted in FIGS. 2A-2C, respectively;

FIGS. 5A-5C are front views of the horizontal overlapping blind apparatus, with the blind slats in place, showing the overlapping blinds in the positions of FIGS. 3A-3C, respectively;

FIGS. 6A-6C are front views of the horizontal overlapping blind apparatus, with the blind slats in place, showing the overlapping blinds in the positions of FIGS. 4A-4C, respectively;

FIG. 7 is an elevational view of a portion of the horizontal overlapping blind apparatus, with the blind slats in place, showing a central lifting string partially raised;

FIGS. 8A and 8B are sectional views of hinged slats in various positions, showing a central lifting string extending through an aperture in the first and second slat;

FIG. 8C is a sectional view of another embodiment for a hinged slat;

FIGS. 9A and 9B are front and side views of a vertical overlapping blind apparatus showing a support cord positioned through apertures in each slat to support the slats in vertical alignment;

FIGS. 10A-10C and 11A-11C are top views of the vertical overlapping blind apparatus of FIG. 9 in various positions;

FIG. 12 is a side view of an alternate embodiment of the overlapping blind apparatus, shown without slats, and is constructed in accordance with the present invention; and

FIG. 13 is an enlarged side view of a portion of the apparatus of FIG. 12 and is shown with slats.

### DETAILED DESCRIPTION OF THE INVENTION

This application is related to U.S. Pat. No. 6,644,377, to Lewis, which is incorporated herein by reference.

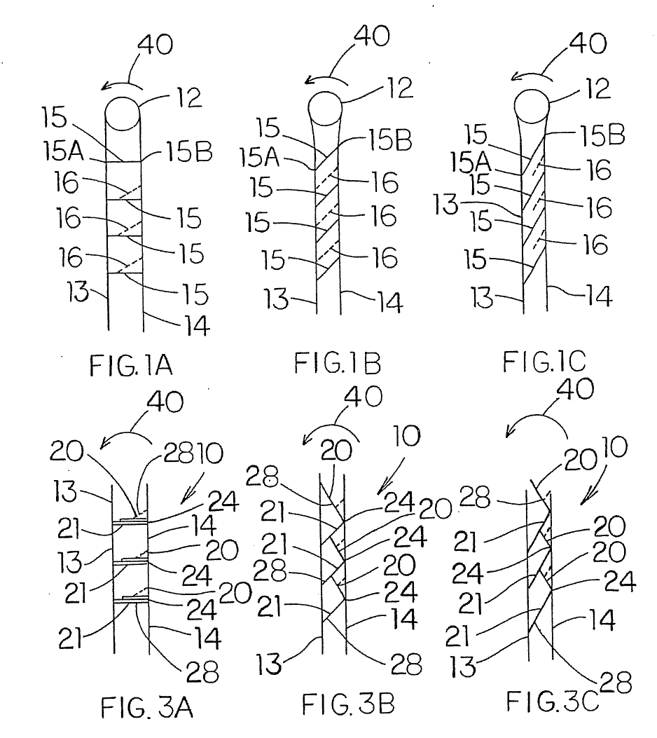

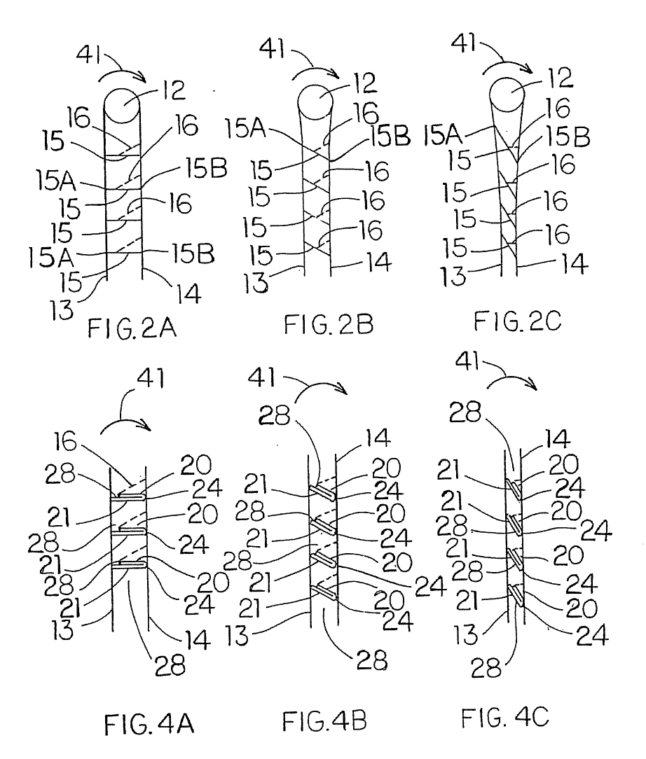

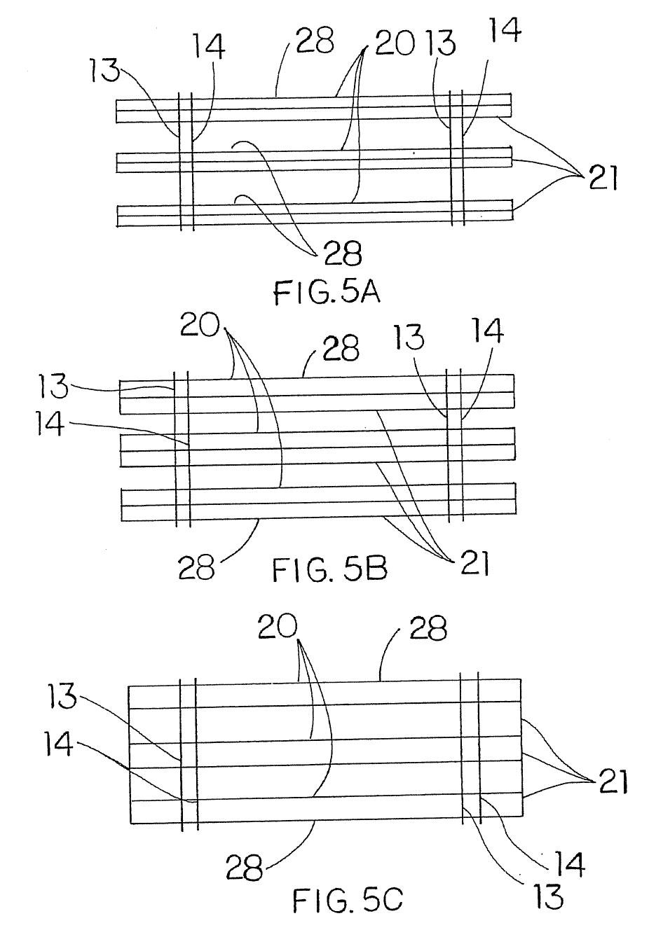

The overlapping blind apparatus 10 shown in detail in FIG. 1A through FIG. 1C, FIG. 3A through FIG. 3C, and FIG. 5A through FIG. 5C, show one embodiment of the overlapping blind apparatus, when the first pulley rod 12 is rotated in a counter-clockwise position, as shown by arrow 40. The overlapping blind apparatus 10 shown in detail in FIGS. 2A through 2C, FIGS. 4A through 4C and FIGS. 6A through 6C show the overlapping blind apparatus, when the first pulley rod 12 is rotated in a clockwise position, as shown by arrow 41.

The overlapping blind apparatus 10 has a first pulley rod 12 that rotates in either clockwise or counter-clockwise directions. First and second ladder strings 13, 14 are biased by the first pulley rod 12, which is partially rotated to selectively raise or lower the ladder strings 13, 14. When the first pulley rod 12 is horizontally rotated in a counter-clockwise position as shown by arrow 40, in FIGS. 1A through 1C, FIGS. 3A through 3C, and FIGS. 5A through 5C, the first ladder string 13 is lowered, as the second ladder string 14 is raised. There are at least two sets of first and second ladder stings 13, 14 positioned in spaced relation along the first pulley rod 12.

When the first pulley rod 12 is horizontally rotated in a clockwise position as shown by arrow 41 in FIGS. 2A through 2C, FIGS. 4A through 4C and FIGS. 6A through 6C, the first ladder string 13 is raised, as the second ladder string 14 is lowered. Thus, the first pulley rod 12 of the overlapping blind apparatus 10 can be horizontally rotated either clockwise or counter-clockwise, to selectively raise or lower the first ladder string 13, while the second ladder string 14 moves in a direction opposite to the first ladder string 13.

A plurality of bridging strings 15 are each secured in a spaced parallel alignment between the first and second ladder strings 13, 14. The first end 15A of each bridging string 15 is secured to the first ladder string 13, while the second end 15B of each ladder string 15 is secured to the second ladder string 14. The bridging strings 15 are spaced substantially equally apart. In one embodiment, the distance between bridging strings 15 is selected to be from about three quarters of an inch to about four inches apart. Specifically, the width of each second slat 21 is more than about one-half the distance between the bridging strings 15. Thus, when the first pulley rod 12 is horizontally rotated counter-clockwise in the direction shown by arrow 40, the first ladder string 13 is lowered, while the second ladder string 14 is raised. This tilts the bridging strings 15, as shown in FIGS. 1B and 1C, and in FIGS. 3B and 3C.

When the first pulley rod 12 is horizontally rotated clockwise, in the direction shown by arrow 41, the first ladder string 13 is raised, while the second ladder string 14 is lowered. This tilts the bridging strings 15, as shown in FIGS. 2B and 2C and in FIGS. 4B and 4C. The louver strings 16 are attached to the second ladder string 14 in spaced relation. The louver strings 16 are attached at a first end to the second ladder string 14 and at a second end to the outer surface of the first slat 20. Because the second end of the louver strings 16 are not attached to the first ladder string 13, the louver strings 16 are angled upward or downward only by actuation of the second ladder string 14.

FIG. 3A, FIG. 3B and FIG. 3C show the same views as FIG. 1A, FIG. 1B and FIG. 1C, respectively, but with a first slat 20, and a second slat 21 in place between the first and second ladder strings 13, 14. In one embodiment, the first slat 20 is narrower in width than the second slat 21. One end 26 (FIGS. 8A and 8B) of each first slat 20 is pivotally secured by a hinge means 22 to an adjacent end 27 of a second slat 21, thereby forming a hinged end 24 therebetween. Multiple hinged sets of overlapping blinds 28 are used to form the overlapping blind apparatus 10 disclosed herein. The hinge means 22 of overlapping blinds 28 is positioned and secured adjacent to the second ladder string 14.

The hinge means 22 in one embodiment comprises an in-line crease along the length of a single large slat that is folded over on itself along the crease to form a first slat portion 20 and a second slat portion 21. Other known means of hinging the first slat 20 to the second slat 21 also may be used. In other embodiments, the hinge means 22 comprises a flexible sheet material, such as fabric or film material, secured to adjacent first and second slats 20, 21 on their respective outer surfaces 48, 49 or inner surfaces 46, 47. The first and second slats 20, 21 are preferably made of a material selected from: plastic, wood, fiberglass, fabric and/or metal.

Each first slat 20 is secured to the next adjacent louver string 16. Thus, when the first pulley rod 12 is partially, horizontally rotated counter-clockwise, as shown by arrow 40, each of the plurality of first slats 20 is raised by the respective plurality of louver strings 16. This causes each of the first slats 20 to pivot about the hinge means 22 at the hinged end 24 in relation to the second slat 21. While the first slat 20 is raised, the second slat 21 is lowered by the tilting bridging string 15, forming a V-shaped slat assembly. The slat assembly is inclined towards the first ladder string 13, as shown in FIGS. 3B and 3C and FIGS. 5B and 5C.

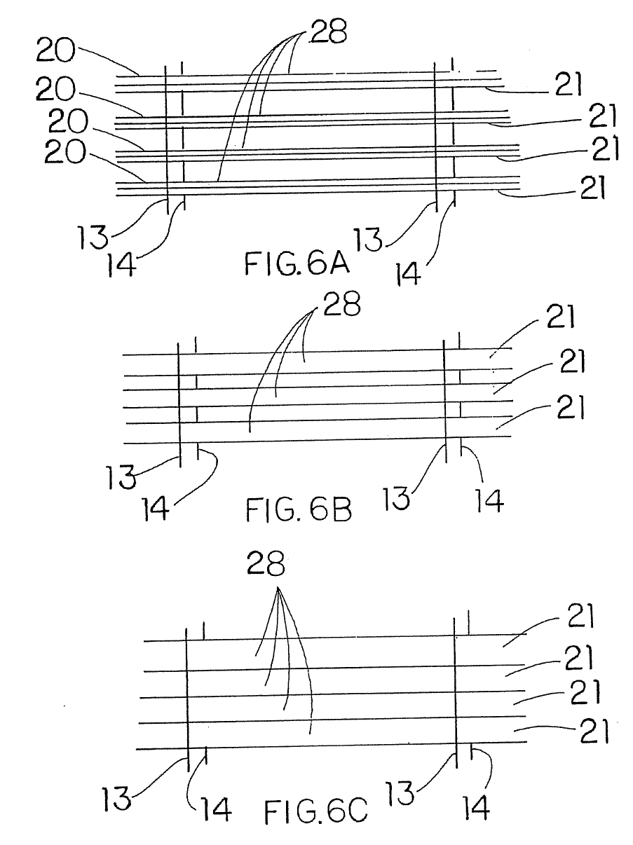

However, when the first pulley rod 12 is partially rotated clockwise, the first slat 20 remains in a closed position substantially parallel to the second slat 21, as the second slat 21 is inclined towards the second ladder string 14, as best shown in FIGS. 4B-4C and FIGS. 6B-6C. This is made possible because the louver string 16 and the second ladder string 14 are lowered together when the first pulley rod 12 is partially rotated clockwise. While the second ladder string 14 is lowered, the first ladder string 13 is raised by the clockwise movement of the first pulley rod 12, which in turn inclines the second slat 21 in a direction parallel to the position of the first slat 20.

With the overlapping blind apparatus 10 positioned as shown in FIG. 3A and FIG. 5A, the first slat 20 rests upon the second slat 21 of each blind set 28. In this position, the second slat 21 and first slat 20 are substantially parallel to each other, with each hinged set of overlapping blinds 10 in a substantially closed position 24. When the multiple blind sets 28 are positioned in this manner, they resemble regular mini-blinds and essentially allow the most light and view through the multiple blind sets 28.

When the first pulley rod 12 is partially moved counter-clockwise in the direction of arrow 40, the first and second slats 20, 21 are partially extended into an open position about the hinge means 22 at the hinged end 24, as shown in FIGS. 3B and 5B. When the first pulley rod 12 is further moved counter-clockwise in the direction of arrow 40, the first and second slats 20, 21 are further extended into an open position in a V-shape about the hinge means 22 at the hinged end 24, as shown in FIGS. 3C and 5C.

However, when the first pulley rod 12 is moved in a clockwise position in the direction of arrow 41, the first and second slats 20, 21 partially tilt, but remain in a substantially closed, parallel alignment, as shown in FIGS. 4B and 6B. When the first pulley rod 12 is further moved clockwise in the direction of arrow 41, the first and second slats 20, 21 tilt further, but remain in a substantially closed, parallel alignment, as shown in FIGS. 4C and 6C. Thus, when the first pulley rod 12 is moved in a clockwise direction as shown by arrow 41, the overlapping blind apparatus 10 acts in a manner similar to conventional mini-blinds. However, the upper and lower slats 20, 21 serve to increase the opaqueness of the overlapping blinds, due to the double thickness of the slats 20, 21 as shown in FIGS. 4B-4C and FIGS. 6B-6C.

When the first pulley rod 12 is moved in a counter-clockwise direction, as shown by arrow 40, the overlapping blind apparatus 10 provides an entirely different appearance, wherein the hinged first and second slats 20, 21 open in a V-shape about the hinge means 22 at the hinged end 24, as shown in FIGS. 3B-3C and FIGS. 5B-5C.

Indicia 44, such as color, texture, patterns or designs may be incorporated onto the first and second slats 20, 21, as shown in FIG. 8A. This provides an attractive appearance, which changes the appearance of the first and second slats 20, 21, as they are selectively moved by the clockwise and counterclockwise movement of the first pulley rod 12. For example, if the inner sides 46, 47 of the first and second slats 20, 21 contain indicia 44, it would be easily seen from inside the room, as the overlapping blind apparatus 10 is positioned as shown in FIGS. 3B-3C and 5B-5C. However, it would not be visible from inside the room, when the overlapping blind apparatus 10 was positioned as shown in FIGS. 4B-4C and 6B-6C.

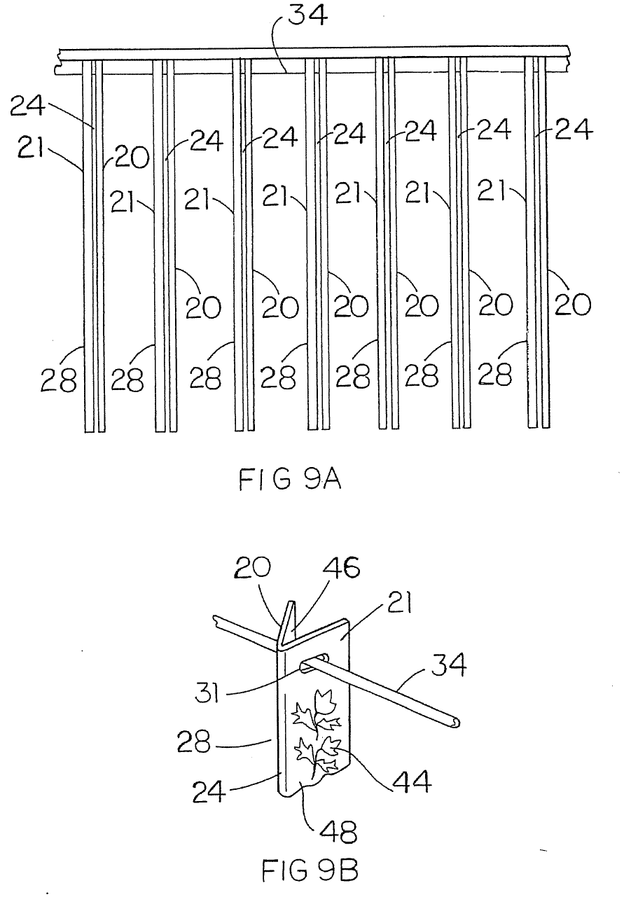

Conversely, indicia 44 may be placed on the outer surfaces 48, 49 of the first and second slats 20, 21, as shown in FIGS. 8B and 9B. The indicia 44 is not visible from inside the room when the overlapping blind apparatus 10 is positioned as shown in FIGS. 3A-3C and FIGS. 5A-5C, but would become visible from inside the room, when the first and second slats were moved into the positions shown in FIGS. 4B-4C and 6B-6C.

In the fully extended position shown in FIG. 3C and FIG. 5C, the second slat 21 of each set of overlapping blinds 28 substantially overlaps the first slat 20 of the next adjacent set of overlapping blinds 28. This results in improved light blockage, which is advantageous for individuals who prefer a darker sleeping environment. This movement positions the first and second slats 20, 21 at their most extended position. In this position, the first slat 20 rests against the bottom portion of the next adjacent, second slat 21. This overlap effectively blocks light leakage through the first and second slats 20, 21 from above and below or to either side of the overlapping blind apparatus 10. Moreover, the overlapping blind apparatus 10 completely seals the window from view, so that people cannot look into a room through the plurality of overlapping first and second slats 20, 21.

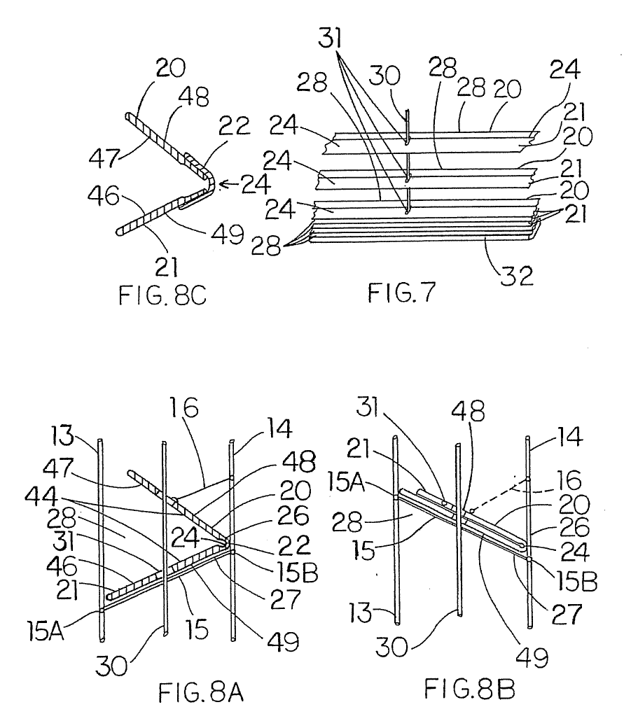

When the first and second slats 20, 21 are mounted horizontally, as shown in FIG. 7, an optional lifting string 30 may be adapted to raise or lower the overlapping blind apparatus 10 disclosed herein. The lifting string 30 will not hamper the operation of the horizontal overlapping blind apparatus 10, because the first slats 20 in one embodiment are narrower than the second slats 21, and an elongated aperture 31 is provided in each of the first and second slats 20, 21. The central lifting string 30 passes through the elongated apertures 31 in each of the first and second overlapping slats 20, 21, as shown in FIG. 8A and FIG. 8B. The lifting string 30 allows the user to raise or lower the bottom portion 32 of the overlapping blind apparatus 10 in a conventional manner, as shown in FIG. 7. The lifting string 30 in one embodiment is centrally positioned in spaced relation between the sets of first and second ladder strings 13, 14.

When the first and second slats 20, 21 are mounted vertically, as shown in FIGS. 9-11, a horizontal rod or cord 34 extends through elongated apertures 31 aligned in each of the plurality of first and second slats 20, 21. The horizontal rod or cord 34 supports the first and second slats 20, 21 in an aligned, vertical position between first and second spaced, vertically aligned pulley rods 12, 18.

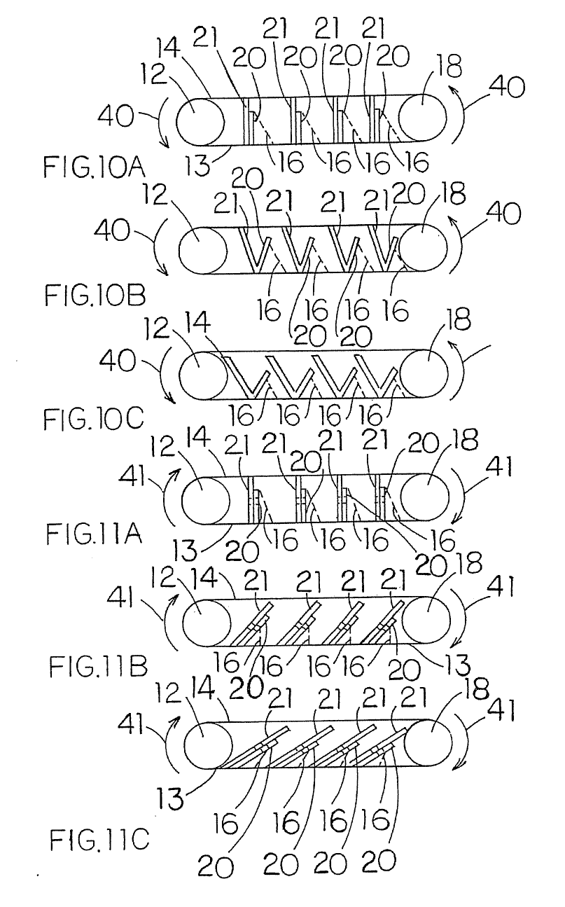

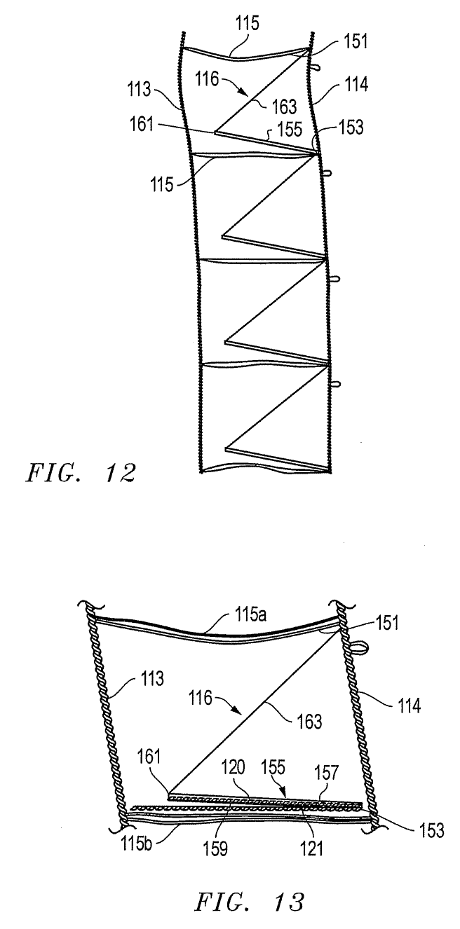

The vertical actuation of the first and second vertical pulley rods 12, 18 (FIGS. 10-11) biases the first and second slats 20, 21 in the same manner as the horizontal actuation of the first and second horizontal pulley rods 12, 18 noted above. Thus, this apparatus is adapted for mounting in either vertical or horizontal positions.

FIGS. 10A through 10C show the vertical blind apparatus 10, wherein the first and second slats 20, 21 are selectively positioned by counter clockwise 40 rotation of the first and second pulley rods 12, 18. FIGS. 11A through 11C show the vertical blind apparatus 10 wherein the first and second slats 20, 21 are selectively positioned by clockwise rotation 41 of the first and second pulley rods 12, 18. Note that in FIG. 10, counter-clockwise 40 rotation results in a V-shaped separation of the first and second slats 20, 21, whereas clockwise 41 rotation of the first and second pulley rods 12, 18 result in adjacent inclined alignment of the first and second slats 20, 21. Although only one set of louver strings 16 are shown, a second or additional sets of opposing louver strings 16 may be employed to effect movement of first slats 20 from the V-shaped separations to positions parallel to second slats 21.

Referring now to FIGS. 12 and 13, another embodiment of the present invention is shown. This design depicts an alternate means of attaching the louver strings 116 and the first and second slats 120, 121. All other features, elements, and operation of the present invention may be designed in accordance with foregoing description. For example, the blind apparatus includes first and second ladder strings 113, 114 and bridging strings 115.

However, louver strings 116 have first ends 151 (FIG. 13—shown with slats 120, 121) that are attached at or near the same area as one end of a first adjacent bridging string 115a, and a second ends 153 that are attached at or near the same area as one end of a second adjacent bridging string 115b. Each louver string 116 also forms a loop 155 (FIG. 12—shown without slats 120, 121) that encircles a first slat 120 as shown in FIG. 13. The size of loop 155 is closely sized to first slat 120 to precisely circumscribe its outer perimeter (in side section). In one embodiment, this designs avoids the need to modify the rectangular first slats 120. The first slats 120 may be hinged to or separate from the second slats 121, and may be independently movable. In the latter embodiment, the first slats 120 simply rest on top of the second slats 121 such that a natural hinge is created via leverage and gravity. In addition, the positions of the first and second slats 120, 121 may be reversed, such that the first slats 120 are located below respective ones of the second slats 121.

The two string pieces 157, 159 that form loop 155 are joined to each other and second ladder string 114 (and/or bridging string 115) at second end 153, and are joined at an intermediate position 161 (approximately the midpoint) of louver string 116. In another embodiment, the upper string piece 157 is not used so that loops are not formed around the slats. Rather, the lower string pieces 159 (i.e., support strings) are sufficient to operate the blind as described herein with substantially equivalent geometry. The portion of louver string 116 extending between intermediate position 161 and first end 151 forms a hypotenuse 163 of a right triangle when loop 155 lays flat (i.e., horizontal) with the adjacent bridging string 115b and respective first and second slats 120, 121.

While the invention has been shown or described in only some of its forms, it should be apparent to those skilled in the art that it is not so limited, but is susceptible to various changes without departing from the scope of the invention. For example, the present invention is readily adaptable to all types and sizes of blinds including Venetian blinds, mini-blinds, vertical blinds, etc., and may comprise curved slats, S-shaped slats, etc.

What is claimed is:

1. A movable blind apparatus, comprising:
a plurality of ladder strings having a plurality of bridging strings;
a plurality of first slats located between the ladder strings;
a plurality of second slats located on respective ones of the bridging strings adjacent respective ones of the first slats;
a plurality of louver strings for moving respective ones of the second slats with respect to the first slats, wherein the louver strings:
have first ends attached adjacent respective first ones of the bridging strings, and second ends attached adjacent respective second ones of the bridging strings; and
form support strings for respective ones of the first slats.

2. A movable blind apparatus according to claim 1, wherein a size of each support string is closely sized to a respective one of the first slats.

3. A movable blind apparatus according to claim 1, wherein the first slats are separate from and independently movable relative to the second slats.

4. A movable blind apparatus according to claim 1, wherein respective second ends of the louver strings form ends of the support strings that are joined to either: (a) one of the ladder strings, or (b) respective second ones of the bridging strings.

5. A movable blind apparatus according to claim 1, wherein the support strings are joined to approximate midpoints of respective ones of the louver strings.

6. A movable blind apparatus according to claim 5, wherein a portion of respective ones of the louver strings that extends between the approximate midpoints and the first end forms a hypotenuse of a right triangle when the support strings lay flat with respective ones of the first slats, second slats, and bridging strings.

7. A movable blind apparatus, comprising:
front and rear ladder strings having a plurality of bridging strings extending therebetween;
a plurality of lower slats located on respective ones of the bridging strings;
a plurality of upper slats located adjacent respective ones of the lower slats;
a plurality of louver strings for moving respective ones of the upper slats with respect to the lower slats, wherein the louver strings:
have first ends attached adjacent respective upper ones of the bridging strings, and second ends attached adjacent respective lower ones of the bridging strings; and
form loops around respective ones of the upper slats.

8. A movable blind apparatus according to claim 7, wherein a size of each loop is closely sized to a respective one of the upper slats to precisely circumscribe an outer perimeter thereof.

9. A movable blind apparatus according to claim 7, wherein the upper slats rest on top of respective ones of the lower slats to form natural hinges via leverage and gravity.

10. A movable blind apparatus according to claim 7, wherein the upper slats are separate from and independently movable relative to the lower slats.

11. A movable blind apparatus according to claim 7, wherein positions of the upper and lower slats are reversed, such that the upper slats are located below respective ones of the lower slats.

12. A movable blind apparatus according to claim 7, wherein each of the loops is formed at least in part from two string pieces that are joined to each other, and respective second ends of the louver strings form ends of the loops that are joined to one of: (a) the rear ladder string, and (b) respective lower ones of the bridging strings.

13. A movable blind apparatus according to claim 12, wherein respective ones of the two string pieces of each loop are joined to each other at an intermediate position approximately at a midpoint of respective ones of the louver strings.

14. A movable blind apparatus according to claim 13, wherein a portion of respective ones of the louver strings that extends between the intermediate position and the first end forms a hypotenuse of a right triangle when the loops lay flat with respective ones of the upper slats, lower slats, and bridging strings.

15. A movable blind apparatus, comprising:
front and rear ladder strings having a plurality of bridging strings extending therebetween;
a plurality of lower slats located on respective ones of the bridging strings;
a plurality of upper slats located adjacent respective ones of the lower slats;
a plurality of louver strings for moving respective ones of the upper slats with respect to the lower slats, wherein the louver strings:
have upper ends attached to respective upper ones of the bridging strings, and lower ends attached to respective lower ones of the bridging strings;
form loops around respective ones of the upper slats; wherein a size of each loop is closely sized to a respective one of the upper slats to precisely circumscribe an outer perimeter thereof; and
each of the loops is formed from two string pieces that are joined to each other, and respective lower ends of the louver strings form ends of the loops that are joined to respective lower ones of the bridging strings.

16. A movable blind apparatus according to claim 15, wherein the upper slats are separate from and independently movable relative to the lower slats, and the upper slats rest on top of respective ones of the lower slats to form natural hinges via leverage and gravity.

17. A movable blind apparatus according to claim 16, wherein respective ones of the two string pieces of each loop are joined to each other at an intermediate position approximately at a midpoint of respective ones of the louver strings; and
a portion of respective ones of the louver strings that extends between the intermediate position and the upper end forms a hypotenuse of a right triangle when the loops lay flat with respective ones of the upper slats, lower slats, and bridging strings.
